(19) United States
(12) Patent Application Publication
(10) Pub. No.: US 2012/0308416 A1
(43) Pub. Date: Dec. 6, 2012

(54) COOLING FAN AND ROTOR THEREOF

(75) Inventors: HONG-TAO WU, Shenzhen City (CN); YONG-KANG ZHANG, Shenzhen City (CN); YUNG-PING LIN, Tu-Cheng (TW)

(73) Assignees: FOXCONN TECHNOLOGY CO., LTD., Tu-Cheng (TW); FU ZHUN PRECISION INDUSTRY (SHEN ZHEN) CO., LTD., Shenzhen City (CN)

(21) Appl. No.: 13/338,277

(22) Filed: Dec. 28, 2011

(30) Foreign Application Priority Data
May 31, 2011 (CN) 201110143724.8

(51) Int. Cl. F04B 35/04; H02K 1/27

(52) U.S. Cl. 417/423.1; 310/156.01

(57) ABSTRACT

A cooling fan includes a fan housing, a stator and a rotor received in the fan housing. The rotor includes a shaft, a hub engaged with the shaft, a plurality of rotary blades extending outwardly from the hub, a connecting member and a magnet mounted in the connecting member. The hub includes a plurality of hooks. The connecting member has a flange clasping the hooks of the hub to mount the magnet in the hub.

### BACKGROUND

1. Technical Field

The present disclosure relates generally to cooling fans, and more particularly to a rotor of a fan.

2. Description of Related Art

Cooling fans are commonly used in combination with heat sinks for cooling electronic components, such as CPUs. Normally, the heat sink is arranged on the electronic component to absorb heat therefrom, while the cooling fan is arranged on the heat sink to produce forced airflow flowing through the heat sink to take away the heat.

Generally, the cooling fan includes a hub, a plurality of blades extending outwards from the hub and a magnet engaged in the hub. In a big cooling fan, the magnet is large and heavy thereby easily falling from the hub. As a result, the cooling fan is easily out of work.

What is needed is a cooling fan which can overcome the limitations described.

### BRIEF DESCRIPTION OF THE DRAWINGS

FIG. 1 is an assembled, isometric view of a cooling fan in accordance to an embodiment of the present disclosure.

FIG. 2 is an exploded view of the cooling fan of FIG. 1.

FIG. 3 is an assembled, inverted view of a stator without a magnet of the cooling fan of FIG. 1.

FIG. 4 is an exploded view of the stator of FIG. 3.

FIG. 5 is a cross-sectional view of the cooling fan along a line V-V of FIG. 1.

FIG. 6 is an enlarged view of a circled portion VI of FIG. 5.

### DETAILED DESCRIPTION

Embodiments of the disclosure will now be described in detail with reference to the accompanying drawings.

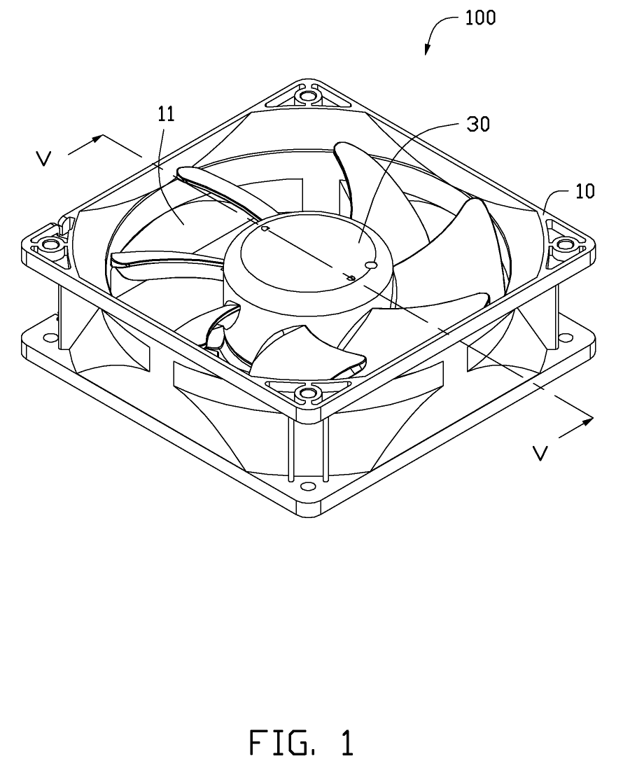

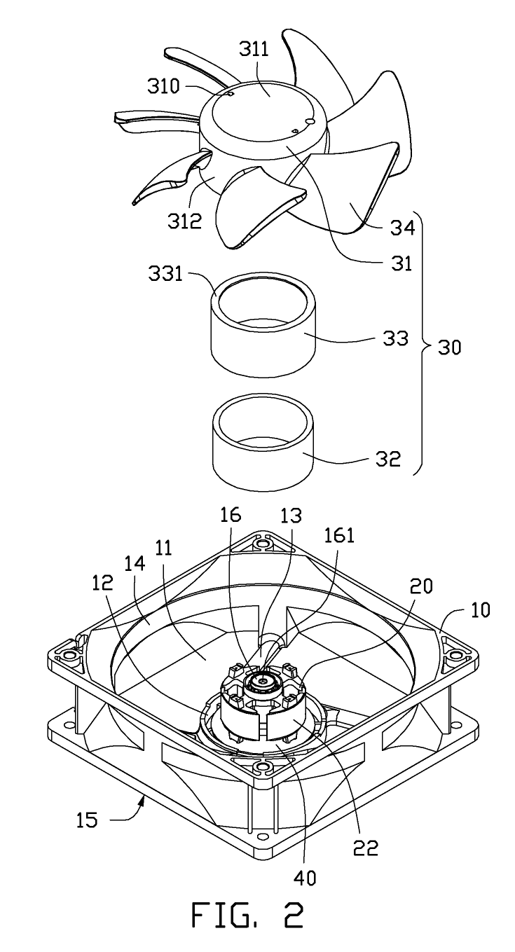

Referring to FIGS. 1 and 2, a cooling fan 100 includes a fan housing 10, a stator 20 and a rotor 30 received in the housing 10.

The fan housing 10 has a cubical configuration and defines an opening 11 to receive the stator 20 and the rotor 30. The fan housing 10 includes a supporting base 12 in a center of a bottom thereof and a plurality of ribs 13 connecting the supporting base 12 and a periphery of the fan housing 10. The opening 11 has an air inlet 14 in a top of the fan housing 10, and an air outlet 15 in a bottom of the fan housing 10. The supporting base 12 includes a bearing 16 in a central portion thereof. The bearing 16 defines a central hole 161.

The stator 20 is mounted on the supporting base 12 and around the bearing 16. The stator 20 includes a plurality of coils 22 wound thereon to establish an alternating magnetic field, and a PCB (printed circuit board) 40 electrically connected with the coils 22 to control electrical current flowing through the coils 22.

The rotor 30 includes a hub 31, an annular magnet 32, a connecting member 33 and a plurality of rotary blades 34 extending outwardly from the hub 31.

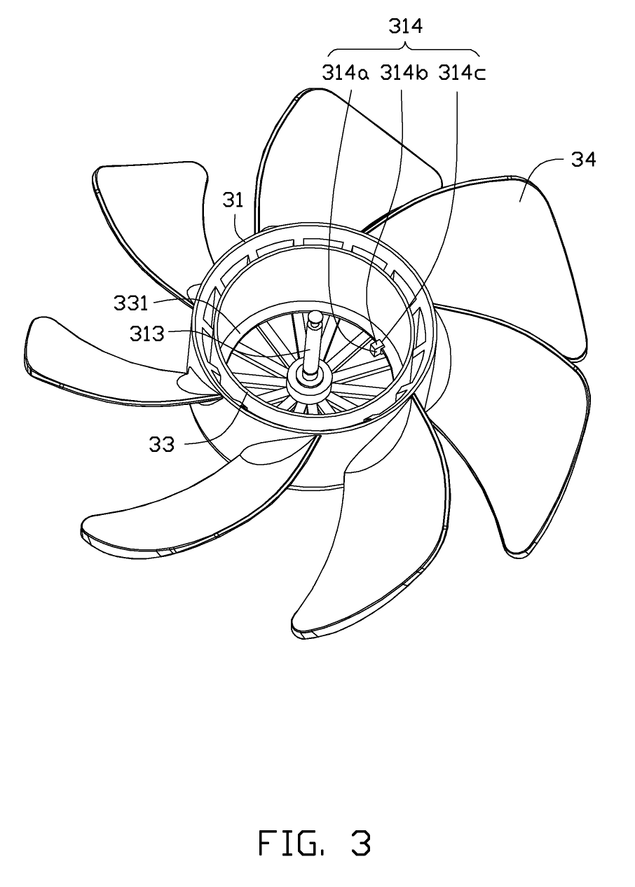

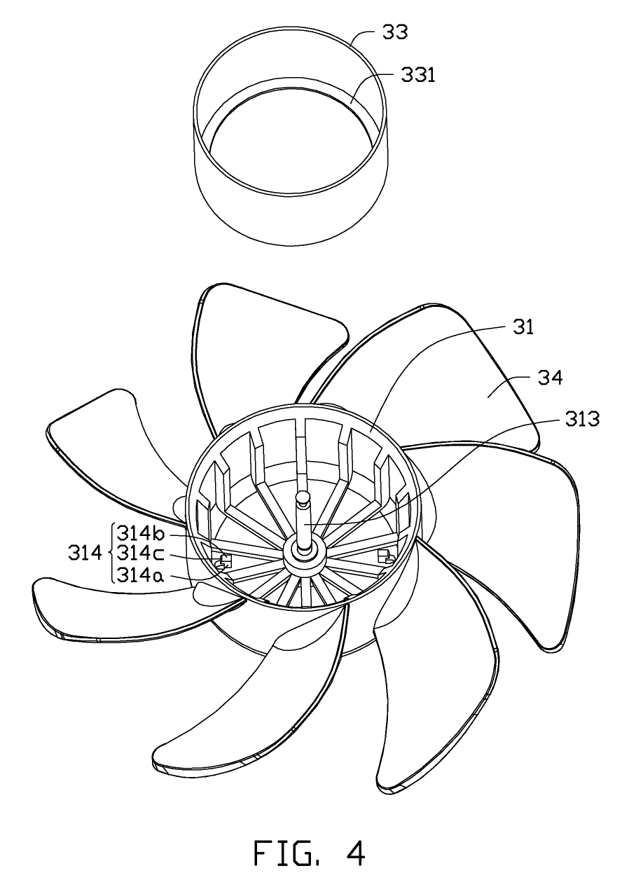

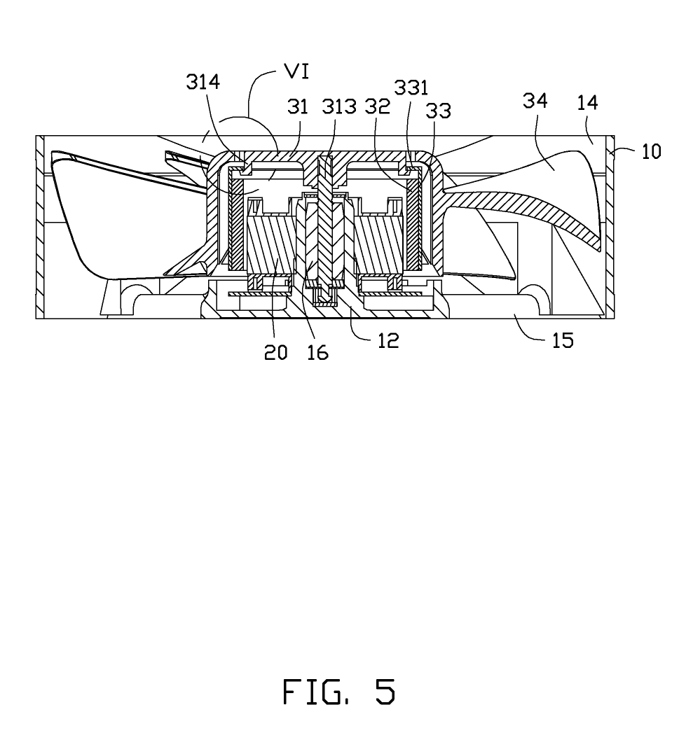

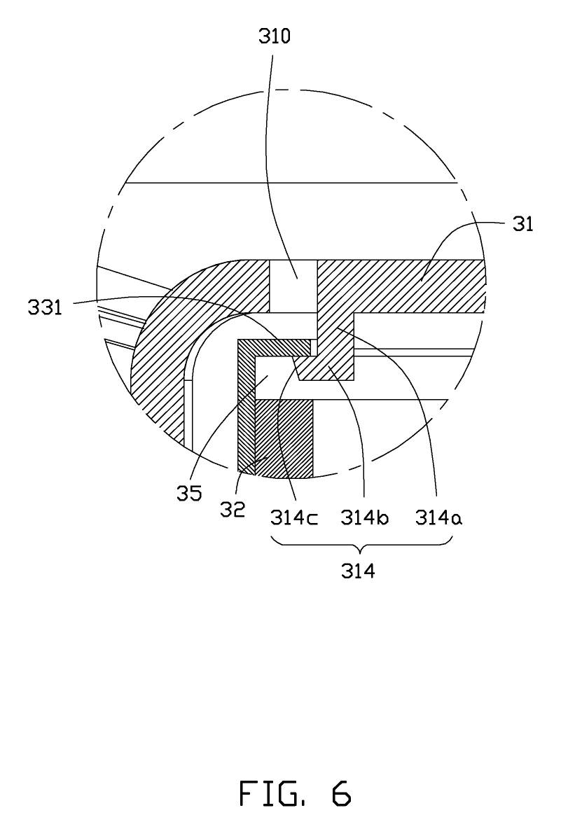

Referring also to FIGS. 3 to 6, the hub 31 includes a circular top wall 311 and an annular lateral wall 312 extending downwards from the top wall 311. The rotor 30 includes a shaft 313 mounted at a center of a bottom of the top wall 311 of the hub 31. The shaft 313 is assembled in the central hole 161 of the bearing 16 and rotatably mounted on the supporting base 12. The top wall 311 includes two hooks 314 extending from the bottom thereof. The hooks 314 are elastic and around the shaft 313. Each of the hooks 314 includes a connecting portion 314a extending vertically from the bottom of the top wall 311, and a clamping portion 314b extending from a bottom end of the connecting portion 314a. The clamping portions 314b of the hooks 314 extends radially and outwardly relative to the shaft 313. An outer end of each of the clamping portions 314b has a slant guiding surface 314c. The hooks 314 are at an imaginary circle with a centre of the shaft 313. In this embodiment, the hooks 314 are centrosymmetric relative to the shaft 313. The top wall 311 defines two uninstalled holes 310 extending through the top wall 311 and near outsides of the hooks 314.

The connecting member 33 is annular to receive the magnet 32. The magnet 32 can be adhered on inner surface of the connecting member 33 or tightly engaged or screwed with the inner surface of the connecting member 33. The connecting member 33 includes an annular flange 331 extending inwards from a top end of the connecting member 33.

In assembly, the magnet 32 is fixedly mounted in the connecting member 33. A top end of the magnet 32 is spaced from the annular flange 331 of the connecting member 33 thereby defining a gap 35 between the magnet 32 and the annular flange 331. The connecting member 33 with the magnet 32 is inserted into the hub 31. The annular flange 331 of the connecting member 33 presses a first face of the clamping portions 314b of the hooks 314 and slides along the guiding surfaces 314c to abut against an opposite second face of the clamping portions 314b. Thereby, the annular flange 331 clasps the hooks 314. The connecting member 33 with the magnet 32 is fixedly mounted in the hub 31. During operation, the rotor 30 is rotated by the interaction of the alternating magnetic field established by the stator 20 and the magnetic field of the magnet 32. The rotary blades 34 thus produce forced airflow to take away heat generated in an application environment that employs the cooling fan 100.

In disassembly, the connecting member 33 with the magnet 32 can escape from the hub 31 by using a screwdriver extending through the uninstalled holes 310 to pressing the hooks 314 to disengage with the connecting member 33.

It is to be understood, however, that even though numerous characteristics and advantages of certain embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A cooling fan comprising:
a fan housing;
a stator received in the fan housing;
a rotor received in the fan housing, the rotor comprising a shaft, a hub engaged with the shaft, a plurality of rotary blades extending outwardly from the hub, a connecting member and a magnet mounted in the connecting member, the hub comprising a plurality of hooks, the connecting member having a flange clasping the hooks of the hub to mount the magnet in the hub.

2. The cooling fan of claim 1, wherein the hub comprises a circular top wall and a lateral wall extending from the top wall, the shaft and the hooks extending from the top wall towards stator.

3. The cooling fan of claim 2, wherein the hooks are positioned at a circle with a centre of the shaft.

4. The cooling fan of claim 2, wherein the connecting member is annular, the flange extending inwards from a top end of the connecting member.

5. The cooling fan of claim 4, wherein each of the hooks comprises a connecting portion extending vertically from the bottom of the top wall, and a clamping portion extending outwards from a bottom end of the connecting portion.

6. The cooling fan of claim 1, wherein each of the hooks is elastics and has a guiding surface extending slant to guide the flange of the connecting member.

7. The cooling fan of claim 1, wherein the magnet is annular and spaced from the flange of the connecting member, a gap being defined between the flange and the magnet to receive the hooks.

8. The cooling fan of claim 7, wherein the magnet is tightly engaged in the connecting member.

9. The cooling fan of claim 7, wherein the magnet is screwedly engaged in the connecting member.

10. The cooling fan of claim 1, wherein the hub defines a plurality of uninstalled holes respectively corresponding to the hooks.

11. A rotor for a cooling fan comprising:
a shaft;
a hub comprising a top wall and a lateral wall extending from an edge of the top wall, a plurality of hooks extending into the hub from the top wall, the shaft being fixed on the top wall;
a connecting member comprising a flange clasping the hooks of the hub to fix the connecting member on the hub; and
a magnet fixed in the connecting member.

12. The rotor of claim 11, wherein the top wall of the hub defines a plurality of uninstalled holes respectively corresponding to the hooks.

13. The rotor of claim 11, wherein the hooks are positioned at a circle with a centre of the shaft.

14. The rotor of claim 11, wherein the connecting member is annular, the flange extending inwards from a top end of the connecting member.

15. The rotor of claim 14, wherein each of the hooks is elastics and comprises a connecting portion extending vertically from the bottom of the top wall, and a clamping portion extending from a bottom end of the connecting portion, the clamping portion having a guiding surface extending slant to face the flange of the connecting member.

16. The rotor of claim 14, wherein the magnet is annular and spaced from the flange of the connecting member, a gap being defined between the flange and the magnet to receive the hooks.
